(19) United States
(12) Patent Application Publication
(10) Pub. No.: US 2014/0180688 A1
(43) Pub. Date: Jun. 26, 2014

(54) SPEECH RECOGNITION DEVICE AND SPEECH RECOGNITION METHOD, DATA BASE FOR SPEECH RECOGNITION DEVICE AND CONSTRUCTING METHOD OF DATABASE FOR SPEECH RECOGNITION DEVICE

(71) Applicant: Samsung Electronics Co. Ltd., Suwon-si (KR)

(72) Inventors: Oh-yun KWON, Seoul (KR); Jae-cheol KIM, Suwon-si (KR); Seung-il YOON, Yongin-si (KR); Cheon-seong LEE, Yongin-si (KR)

(21) Appl. No.: 14/025,276

(22) Filed: Sep. 12, 2013

(30) Foreign Application Priority Data
Dec. 20, 2012 (KR) 10-2012-0149520

(51) Int. Cl. G10L 15/06

(52) U.S. Cl. CPC G10L 15/06
USPC 704/236

(57) ABSTRACT

A speech recognition device comprises, a corpus processor which includes a refiner to classify collected corpora into domains corresponding to functions of the speech recognition device, and an extractor which extracts collected basic sentences based on functions of the speech recognition device with respect to the corpora in the domains, a database (DB) which stores therein the extracted basic sentences based on functions of the speech recognition device, a corpus receiver which receives a user's corpora, and a controller which compares a received basic sentence extracted by the extractor with collected basic sentences stored in the DB and determines the function intended by the user's corpora.

### CROSS-REFERENCE TO RELATED APPLICATION

This application claims priority from Korean Patent Application No. 10-2012-0149520, filed on Dec. 20, 2012 in the Korean Intellectual Property Office, the disclosure of which is incorporated herein in its entirety by reference.

### BACKGROUND

1. Field

Apparatuses and methods consistent with the exemplary embodiments relate to a speech recognition device and a speech recognition method, a database for the speech recognition device and a constructing method of the database for the speech recognition device which refines, extracts and paraphrases a corpus, or a user's speech, used in a conversational system, and uses, as a paraphrasing method, a paraphrasing template enabling systemic paraphrasing based on colloquial characteristics and stages of sentence patterns from the lingual and conversational systemic perspectives.

2. Description of the Related Art

Instead of controlling devices by inputting characters or pressing hot keys through an input device, voice recognition devices which conveniently control other devices through speech according to a user's environment have been developed in recent years.

However, these voice recognition devices are only used for the purpose of generating simple translation sentences having the same meaning based on bilingual system rather than monolingual systems, or for the purpose of removing ambiguity from keywords within the sentence given for searching for information.

Such related art speech recognition devices may be used to simply translate a user's speech (hereinafter, to be called the “corpus”) or may be used to search but cannot recognize a corpus consisting of various sentences used by many users.

Also, other related art speech recognition devices employ a method of recognizing a corpus by linking functions of the devices to preset corpuses. For example, the related art speech recognition devices may be set in advance to recognize the corpus “turn on TV” or “turn off TV” as an ON or OFF command of television (TV) functions in a TV. However, if a user speaks in a metaphorical manner such as “I want to watch TV” or “Let's go to bed”, the TV does not respond to such commands.

### SUMMARY

Accordingly, one or more exemplary embodiments provide a speech recognition device and a speech recognition method which accurately recognizes a user's intention from various corpora of various users.

Another exemplary embodiment provides a speech recognition device and a speech recognition method which refines, extracts and paraphrases various corpora of users consistent with the intent of the user, and enriches the corpora to provide superior voice recognition performance.

Still another exemplary embodiment provides a database for a speech recognition device which systemically paraphrases and stores many corpora of various users based on basic sentences obtained by refining and extracting the corpora of users.

Yet another exemplary embodiment provides a constructing method of a database for a speech recognition device which refines, extracts and paraphrases a user's corpora to systemically obtain abundant corpora data based on the intended function of the user.

According to aspect of an exemplary embodiment, there is provided a speech recognition device including, a corpus processor which includes a refiner to classify collected corpora into domains consistent with intended functions of the speech recognition device, and an extractor which extracts collected basic sentences by function of the speech recognition device with respect to the corpora in the domains, a database (DB) which stores therein the extracted basic sentences by function of the speech recognition device, a corpus receiver which receives a user's corpora, and a controller which compares a received basic sentence extracted by the extractor with collected basic sentences stored in the DB and determines the function intended by the user's corpora.

The speech recognition device may further include a function performer which performs the function determined by the controller.

The corpus processor may further include a paraphraser which paraphrases the extracted collected basic sentence and generates paraphrased collected corpora.

The paraphraser may paraphrase extracted basic sentences and generate paraphrased received corpora.

The controller may compare the paraphrased received corpora with the paraphrased collected corpora and determine the function intended by the user.

The refiner may analyze a main act and key object of the collected corpora or received corpora and classify the corpora into domains corresponding to the user's intention.

The extractor may perform at least one of grammatical error filtering, predicate filtering, change of word order filtering, change of sentence pattern filtering, change of word order filtering, modifier filtering, and indirect expression filtering.

The extractor may sequentially perform the grammatical error filtering, predicate filtering and change of vocabulary filtering.

The generation of the paraphrased collected corpora by the paraphraser may be performed in a reverse order of the extraction of the collected basic sentences by the extractor.

The generation of the paraphrased received corpora by the paraphraser may be performed in a reverse order of the extracting of the received basic sentences by the extractor.

The paraphraser may use a paraphrasing template.

A transverse axis of the paraphrasing template may apply one of indirect expression, change of predicate, change of vocabulary, change of sentence pattern, change of word order, and change of modifier, and a vertical axis thereof may apply another one of the indirect expression, change of predicate, change of vocabulary, change of sentence pattern, change of word order, and change of modifier.

According to an aspect of another exemplary embodiment, there is provided a speech recognition method including, classifying collected corpora into domains consistent with functions of the speech recognition device, extracting collected basic sentences by function of the speech recognition device from the corpora in the domains, storing the extracted basic sentences by function of the speech recognition device, receiving a user's corpus, and comparing the received basic sentence extracted from the received corpora with the stored collected basic sentence and determining a function intended by the user's corpus.

The speech recognition method may further include performing the determined function.

The speech recognition method may further include generating paraphrased collected corpora by paraphrasing the extracted collected basic sentence.

The speech recognition method may further include generating paraphrased received corpora by paraphrasing the extracted received basic sentence.

The paraphrased received corpora may be compared with the paraphrased collected corpora to determine a function intended by the user's corpus.

The classifying into domains may include analyzing a main act and key object of the collected corpora or received corpora and classifying the corpora into domains consistent with the user's intention.

The extracting may include performing at least one of grammatical error filtering, predicate filtering, change of vocabulary filtering, change of sentence pattern filtering, change of word order filtering, modifier filtering, and indirect expression filtering.

The extracting may include sequentially performing the grammatical error filtering, predicate filtering and change of vocabulary filtering.

The generating the paraphrased collected corpora may be performed in a reverse order of the extracting of the collected basic sentence.

The generating the paraphrased received corpora may be performed in a reverse order of the extracting of the received basic sentence.

The generating the paraphrased collected corpora or paraphrased received corpora may use a paraphrasing template.

A transverse axis of the paraphrasing template may apply one of indirect expression, change of predicate, change of vocabulary, change of sentence pattern, change of word order, and change of modifier, and a vertical axis thereof may apply another one of the indirect expression, change of predicate, change of vocabulary, change of sentence pattern, change of word order, and change of modifier.

According to an aspect of another exemplary embodiment, there is provided a database for a speech recognition device including, collected basic sentence data which are extracted by classifying collected corpora into domains consistent with functions of the speech recognition device and by performing at least one of grammatical error filtering, predicate filtering, change of vocabulary filtering, change of sentence pattern filtering, change of word order filtering, modifier filtering, and indirect expression filtering with respect to the corpora in the domains.

The database for a speech recognition device may further include paraphrased collected corpora data which are generated by paraphrasing the extracted collected basic sentence.

The database for a speech recognition device may further include received basic sentence data which are extracted from corpora received by the speech recognition device.

The database for a speech recognition device may further include paraphrased corpora data paraphrased from the received basic sentence.

The classification into domains may be determined by analyzing a main act and key object of the collected corpora or received corpora.

The extraction may include performance of grammatical error filtering, predicate filtering and change of vocabulary filtering.

The paraphrased collected corpora data may be obtained by performing in a reverse order of the extracting of the collected basic sentence.

The paraphrased received corpora data may be obtained by performing in a reverse order of the extracting of the received basic sentence.

The paraphrased collected corpora data may be obtained by using a paraphrasing template.

The paraphrased received corpora data may be obtained by using a paraphrasing template.

A transverse axis of the paraphrasing template may apply one of indirect expression, change of predicate, change of vocabulary, change of sentence pattern, change of word order, and change of modifier, and a vertical axis thereof may apply another one of the indirect expression, change of predicate, change of vocabulary, change of sentence pattern, change of word order, and change of modifier.

According to an aspect of another exemplary embodiment, there is provided a constructing method of a database for a speech recognition device including, classifying collected corpora into domains consistent with functions of the speech recognition device and refining the corpora, performing at least one of grammatical error filtering, predicate filtering, change of vocabulary filtering, change of sentence pattern filtering, change of word order filtering, modifier filtering, and indirect expression filtering and extracting a collected basic sentence, and storing the extracted collected basic sentence based on the intended function of the user.

The constructing method of a database for a speech recognition device may further include generating paraphrased collected corpora data by paraphrasing the extracted collected basic sentence.

The constructing method of a database for a speech recognition device may further include extracting received basic sentence data from corpora received by the speech recognition device.

The constructing method of a database for a speech recognition device may further include generating paraphrased corpora data from the received basic sentence.

The refining may be performed by analyzing a main act and key object of the collected corpora or received corpora.

The extracting may include sequentially performing grammatical error filtering, predicate filtering and change of vocabulary filtering.

The generating the paraphrased collected corpora may include performing in a reverse order of extracting the collected basic sentence.

The generating the paraphrased received corpora may include performing in a reverse order of extracting the received basic sentence.

The generating the paraphrased collected corpora may use a paraphrasing template.

The generating the paraphrased received corpora may use a paraphrasing template.

A transverse axis of the paraphrasing template may apply one of indirect expression, change of predicate, change of vocabulary, change of sentence pattern, change of word order, and change of modifier, and a vertical axis thereof may apply another one of the indirect expression, change of predicate, change of vocabulary, change of sentence pattern, change of word order, and change of modifier.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of a speech recognition device according to an exemplary embodiment;

FIG. 2 is a flowchart showing a speech recognition method according to a first exemplary embodiment;

FIG. 3 is a flowchart showing a speech recognition method according to a second exemplary embodiment;

FIG. 4 illustrates a processing flow of a user's corpus according to an exemplary embodiment;

FIG. 5 is a flowchart showing corpus refining and extracting processes according to an exemplary embodiment;

FIG. 6 is a flowchart showing a paraphrasing process according to an exemplary embodiment;

FIG. 7 illustrates a paraphrasing template for a single basic sentence; and

FIG. 8 illustrates a paraphrasing template for a plurality of basic sentences.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

As used herein ‘corpus’ means a collection of actually used language terms or phrases which are spoken or written. Even though the ‘corpus’ means collected language, it is defined herein as including a single speech (sentence).

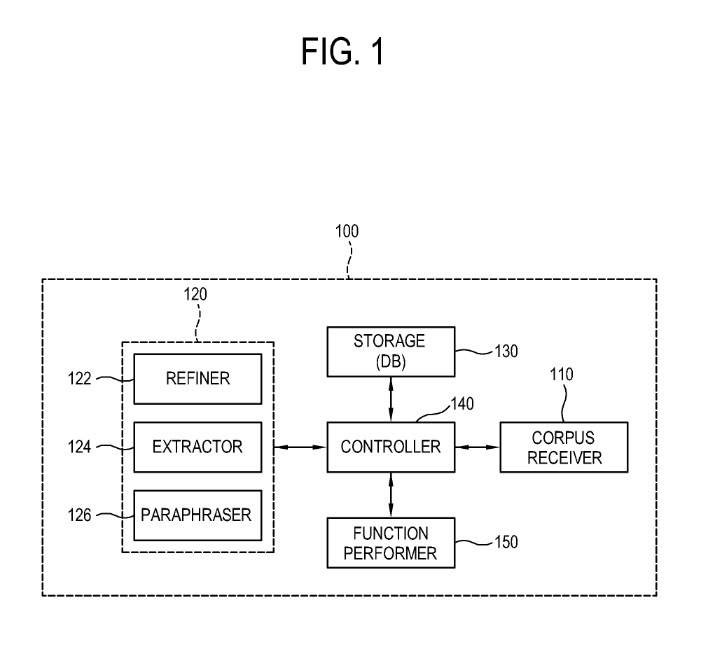

FIG. 1 is a block diagram of a speech recognition device 100 according to an exemplary embodiment. The speech recognition device 100 may include a corpus receiver 110 which receives speeches made by a user with a particular intention (purpose), i.e. receives a corpus, a corpus processor 120 which processes the corpus, a storage (DB) 130 which stores therein processed basic sentences or paraphrased corpus, a controller 140 which controls respective elements of the speech recognition device 100, and a function performer 150 which identifies the intention of the corpus received under the control of the controller 140 and performs a function as intended by the corpus, i.e. one of functions of the speech recognition device 100.

The corpus receiver 110 may receive a user's speech, i.e., corpus, as a direct speech signal through a microphone, as a text or a coded signal through an input device such as a keyboard or mouse, or as corpus data through a communication unit (not shown).

The corpus processor 120 includes a refiner 122 which classifies the corpus received by the corpus receiver 110 into domains consistent with the user's intention, an extractor 124 which extracts basic sentences from the corpus, and a paraphraser 126 which paraphrases the basic sentences using a paraphrasing template, and generates a new corpus.

The refiner 122 may analyze the received corpus, i.e. a main act and key object of the user's speech and classify the corpus into domains consistent with the speech purpose. For example, in a conversational TV system, the intention of the corpus “I want to watch TV” spoken by a user lies in turning on the TV, and thus the corpus may be classified into “turning on TV”. As another example, the intention of the corpus “I'm going to bed” spoken by a user watching a TV drama lies in turning off the TV, and the corpus may be classified into “turning off TV”. As above, the user's corpus may be classified by matching the intention of the user's speech and the function of the speech recognition device 100.

The extractor 124 may perform at least one of grammatical error filtering, modifier filtering, predicate filtering, change of word order filtering, change of sentence pattern filtering, change of vocabulary filtering, and (metaphoric) indirect expression filtering to extract basic sentences. For example, from the corpora “I want to watch TV” and “Let's go to bed”, “turn on TV” and “turn off TV” may be extracted as basic sentences linked to the TV function.

The paraphraser 126 may generate various corpora from basic sentences extracted through the extractor 124 using a paraphrasing template. The paraphrasing method may be performed in a reverse order of the extraction process. For example, if the extraction process has been performed in the order of “grammatical error filtering, predicate filtering, change of vocabulary filtering, change of sentence pattern filtering, change of word order filtering, modifier filtering and indirect expression filtering, the paraphrasing process may be performed in the order of the indirect expression filtering, modifier filtering, change or word order filtering, change of sentence pattern filtering, change of vocabulary filtering, predicate filtering, and grammatical error filtering.

The storage 130 may include a database storing therein the data processed by the corpus processor 120, i.e., extracted basic sentence data and paraphrased corpus data. The storage 130 may temporarily store therein processing and controlling programs for the controller 140 and input/output data.

The storage 130 (DB) may store therein collected basic sentence data which are extracted by classifying collected corpora into domains consistent with the functions of the speech recognition device, and by performing at least one of the grammatical error filtering, predicate filtering, change of vocabulary filtering, change of sentence pattern filtering, change of word order filtering, modifier filtering and indirect expression filtering with respect to the corpora in the domains.

The storage 130 (DB) may further store therein paraphrased collected corpus data which are generated by paraphrasing the extracted collected basic sentences, received basic sentence data extracted from the received corpus received by the speech recognition device, and paraphrased received corpus data.

The storage 130 may include at least one storage medium of a flash memory type, hard disk type, multimedia card micro type, a card-type memory (e.g., SD or XD memory), random access memory (RAM), static random access memory (SRAM), read only memory (ROM), electrically erasable programmable read-only memory (EEPROM), programmable read-only memory (PROM), a magnetic memory, magnetic disk, optical disk, etc.

The controller 140 may control respective elements of the speech recognition device 110. For example, the controller 140 may control the corpus receiver 110 to receive a corpus, control the corpus processor 120 to process the received corpus and extract basic sentences from the corpus consistent with the function of the speech recognition device 100, and paraphrase the basic sentences into various corpora.

The controller 140 may control the storage (DB) 130 to store therein the extracted basic sentences and paraphrased corpus.

The controller 140 may compare the corpus received by the corpus receiver 110 with the corpus stored in the storage 130 and identify the intention of the received corpus, i.e. the function of the speech recognition device 100. Of course, the controller 140 may extract the basic sentence from the received corpus and compare the extracted basic sentence with the basic sentence stored in the storage 130.

After identifying the intention of the received corpus, the controller 140 may control the function performer 150 to perform a function of the speech recognition device 100 intended by the corpus.

The function performer 150 performs the intention of the received corpus under the control of the controller 140. For example, if a received corpus is intended to turn on a TV in a related art TV, a power source (not shown) which turns on the TV may be the function performer 150. If the intention of a received corpus in an air conditioner is to turn the direction of wind toward a user, a wind direction adjuster (not shown) may be the function performer 150.

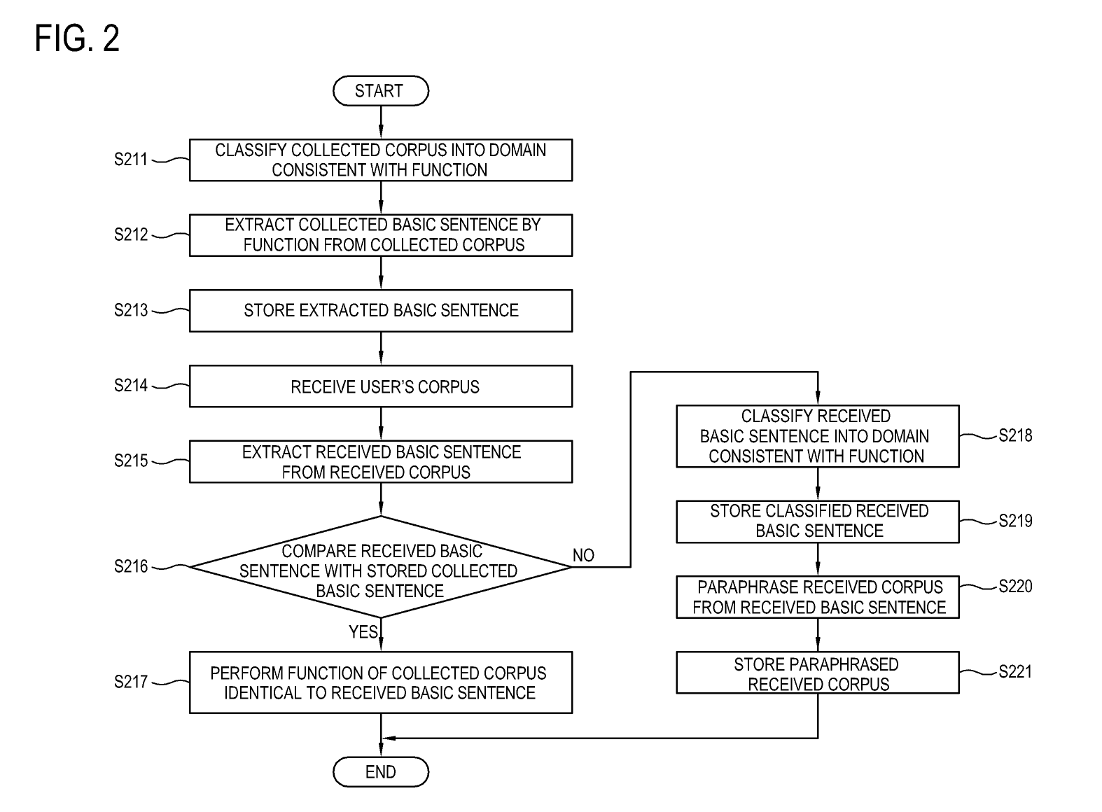

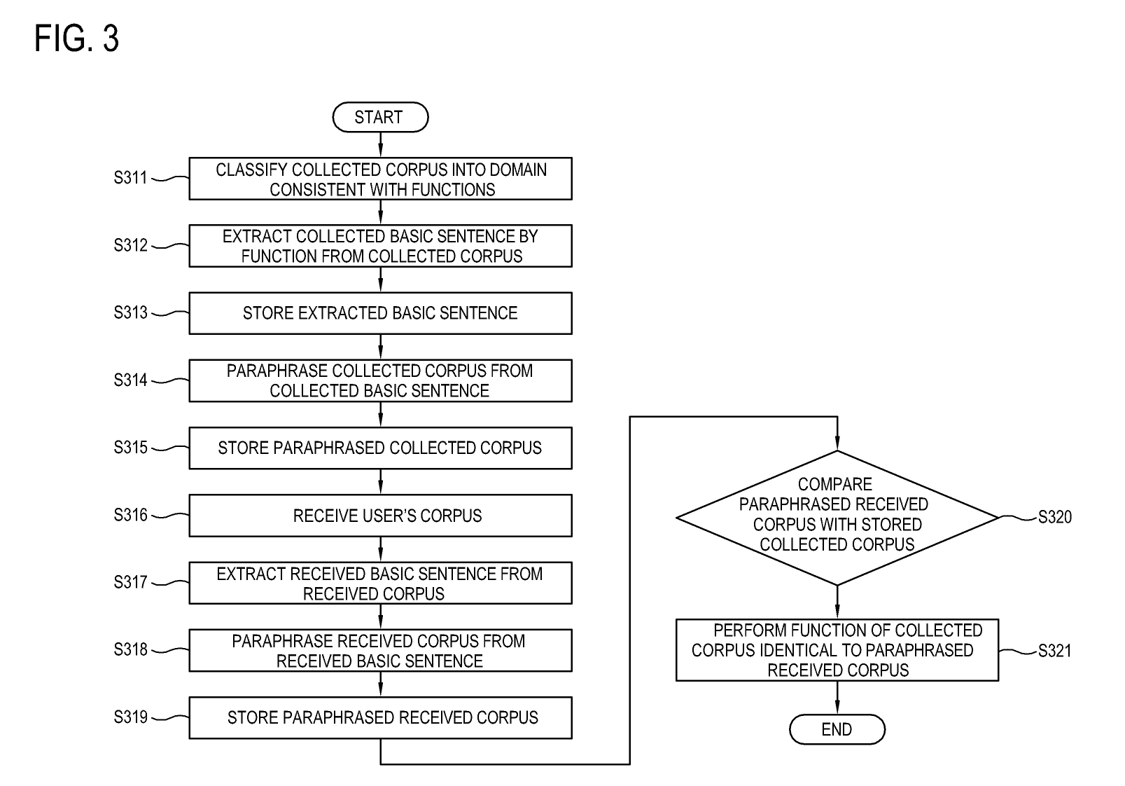

Hereinafter, a speech recognition method will be described in detail with reference to FIGS. 2 and 3.

First, corpora are collected; the function intended by the corpora is identified; and the corpora are classified into domains consistent with the function (operation S211). The function intended by the corpus refers to the function of the speech recognition device 100, and is a user's requirement against the speech recognition device 100. For example, in a conversational TV, basic turn-on, turn-off, change of channel, channel, reservation, recording and notification for a specific program may be functions desired by a user.

After the function is assigned corresponding to the corpus as described above, the grammatical error filtering, predicate filtering, change of vocabulary filtering, change of sentence pattern filtering, change of word order filtering, modifier filtering and indirect expression filtering are performed to extract collected basic sentences (operation S212).

The extracted collected basic sentences are stored in the storage 130 and used as a database (operation S213).

Thereafter, a corpus corresponding to a user's command for performing a function is received by the corpus receiver 110 (operation S214).

The received basic sentences are extracted from the received corpus in a manner similar to the extraction process (operation S215).

The controller 140 compares the received basic sentences with the collected basic sentences stored in the storage 130, and determines whether there is any collected basic sentence identical to the received based sentence (operation S216).

If there is any identical collected basic sentence, the function of the collected basic sentence is performed through the function performer 150 (operation S217).

If there is no identical collected basic sentence, the corpus processor 120 classifies the received basic sentence into a domain consistent with the function (operation S218).

The classified received basic sentence is stored in the storage 130 as a part of the database (operation S219).

Then, the received basic sentence is paraphrased to generate a received corpus (operation S220), and the paraphrased received corpus is stored in the storage 130 as a database.

As above, the corpus may be collected; the basic sentence is extracted from the collected corpus; and the basic sentence may form a database by function. Then, the received basic sentence is extracted from the received corpus and compared with the collected basic sentence of the DB to identify the intention of the received corpus. If the received corpus does not correspond to a previously collected corpus, the received corpus may be newly added to the DB.

FIG. 3 is a flowchart showing a speech recognition method according to another exemplary embodiment.

First, corpora are collected; and the function intended by the corpus is identified to classify the corpora into domains consistent with the function (operation S311). For example, in an air conditioner, basic turn-on, turn-off, adjustment of temperature and wind direction, reservation, etc. may be functions desired by a user.

After the function is assigned corresponding to the corpus as described above, the grammatical error filtering, predicate filtering, change of vocabulary filtering, change of sentence pattern filtering, change of word order filtering, modifier filtering and indirect expression filtering are performed to extract collected basic sentences (operation S312).

The extracted collected basic sentences are stored in the storage 130 and used as a database (operation S313).

The collected corpus is generated using the paraphrasing template based on the extracted basic sentence (operation S314).

The paraphrased collected corpora are stored in the storage 130 as a database (operation S315).

Thereafter, a corpus corresponding to a user's command for performing a function is received by the corpus receiver 110 (operation S316).

The received basic sentences are extracted from the received corpus in a manner similar to the extraction process in relation to the function of the speech recognition device 100 (operation S317).

The extracted received basic sentence is paraphrased using the paraphrasing template to generate new corpora (operation S318).

The paraphrased corpora are stored in the storage 140 (operation S319).

The controller 140 compares the stored received basic sentences with the stored collected basic sentences, and determines whether there are any collected corpora that are identical to the received corpora (operation S320).

If there are any received corpora that are identical to the collected corpora, the function of the collected corpora is performed through the function performer 150 (operation S321).

Even though it is not additionally shown in FIG. 3, if there are no received corpora that are identical to the collected corpora, the operations S218 to S221 in FIG. 2 may be performed to newly add the corpora data.

As described above, collected basic sentences and paraphrased collected corpora linked to functions form the database on the basis of the collected corpora. Based on the corpora received as a user's command, the received basic sentence and the paraphrase received corpora by function are added to the database. Then, it is determined whether there are any collected corpora identical to the received corpora to thereby compare a wider range of objects to improve the rate of recognition. That is, comparing a number of paraphrased and stored collected corpora and the paraphrased received corpora rather than comparing the collected basic sentence and received basic sentence may improve accuracy of recognition.

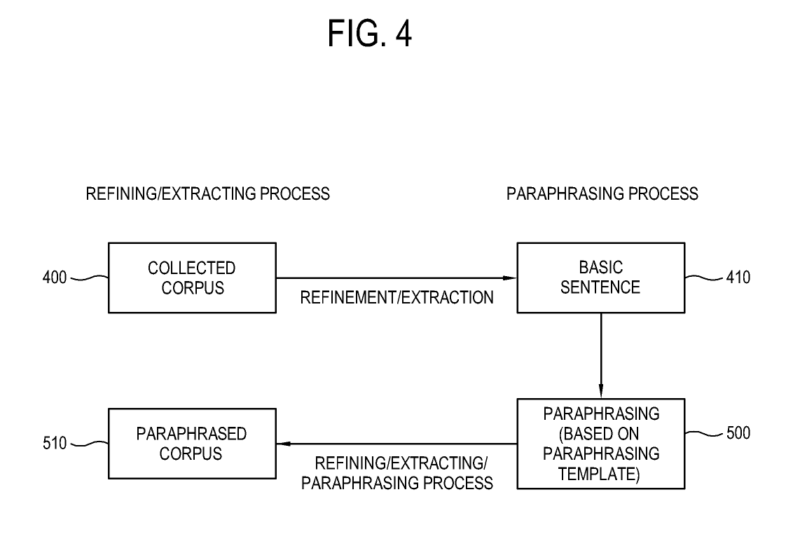

Hereinafter, a constructing method of a database for the speech recognition device will be described in detail with reference to FIGS. 4 to 8.

FIG. 4 briefly shows refining, extracting and paraphrasing processes of a corpus according to an exemplary embodiment. Firstly, the collected corpora are classified into domains consistent with functions according to the intent of a user's speech, and the basic sentences are refined and extracted through various processes (400 and 410). The collected basic sentences as refined and extracted are paraphrased using the paraphrasing template to generate the paraphrased collected corpus (500 and 510).

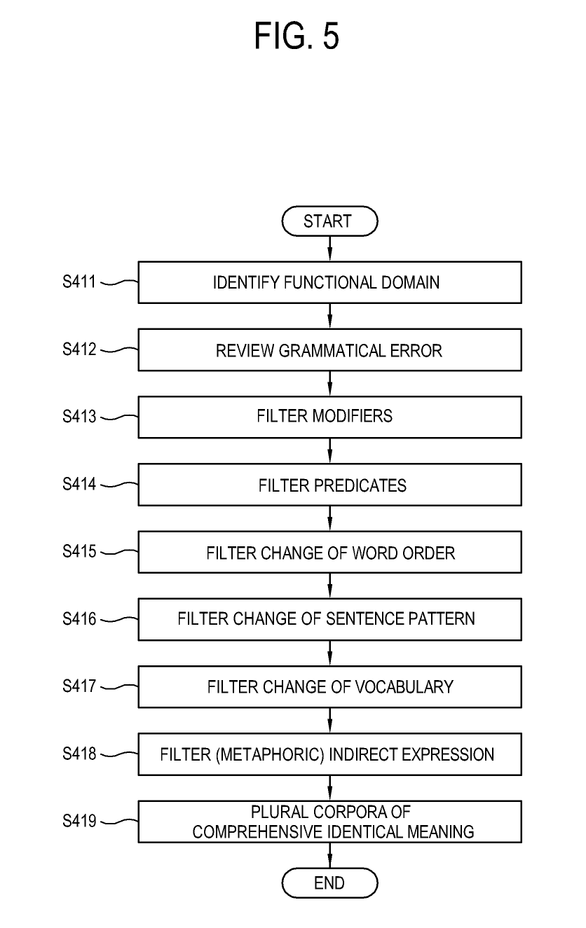

As shown in FIG. 5, the method of refining and extracting the corpus will be described in detail as follows:

The functional domain of the collected corpus is identified according to the functional domain of the user's intention (operation S411).

The grammatical error of the corpora in the domains is checked (operation S412). For example, spelling, orthography, word-spacing, and the used tense may be checked from the corpora.

The modifier filtering is performed to remove any additional noun-repeating modifiers, adjective and adverb modifiers (operation S413).

The predicate filtering is performed to analyze and remove any declinable word and identify the basic stem of words (operation S414). More specifically, the predicate filtering may include removal of conversational words (e.g. abridged words, euphonic replacement, exclamations, non-standard language, non-standard spelling of loan words) based on the change of stem and ending of verbs and adjectives, conversational style (e.g. imperative style).

The change of word order filtering is performed to check a change or non-change of a word order based on main sentence elements and keywords (operation S415). For example, the change of word order filtering includes ‘(subject)+(object)+predicate’, ‘(object)+(subject)+auxiliary/main predicates’, ‘predicate+object’ or ‘(object)+auxiliary predicate+(subject)+main predicate’, and ‘omission of basic component (subject)’.

The change of sentence pattern filtering is performed to remove the sentence pattern in which the grammatical structure has been changed (operation S416). For example, the change of sentence pattern filtering includes the ‘do not’ negative sentence, the ‘cannot’ negative sentence, short negative sentences, long negative sentences, dual negative sentences, and ‘yi, hee, ri, and gi’ passive sentences.

The change of vocabulary filtering is performed with respect to synonyms, antonyms, abbreviated words and coined words of collected corpora for predicates (first priority) and keywords (second priority) (operation S417). The synonyms and antonyms may be checked on the basis of a dictionary DB. The abbreviated words and coined words may be checked on the basis of an actually used and a frequently used terminology DB.

The indirect expression filtering is performed to revise the corpora of direct speech act, indirect speech act, indirect expression (metaphoric expression) into original meanings (operation S418).

The various extraction processes are performed as described above to extract collected basic sentences from a plurality of corpora of comprehensive identical meaning (operation S419).

The extraction processes may be performed randomly, but preferably in sequence. For example, the grammatical error filtering, predicate filtering, and change of vocabulary filtering may be performed in a basic order, and the remaining change of sentence pattern filtering, change of word order filtering, modifier filtering and indirect expression filtering may be performed voluntarily.

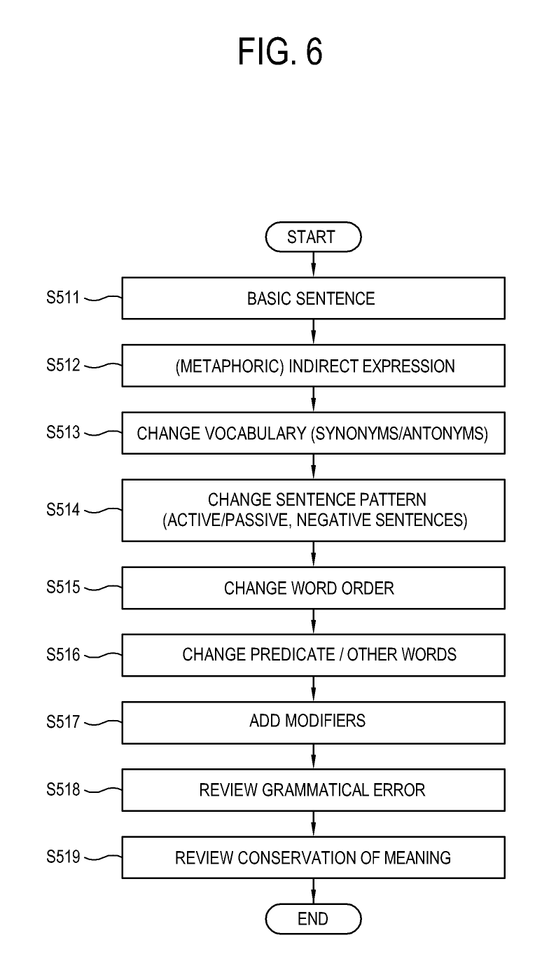

FIG. 6 illustrates a process of paraphrasing and generating a plurality of corpora based on extracted basic sentences. This process may be performed in a reverse order of the extraction process.

First, basic sentences are obtained at the extraction operation (operation S511). The already extracted basic sentences may be used.

The basic sentences are changed in consideration of direct speech act, indirect speech act, and indirect expression (metaphoric expression) (operation S512).

The vocabularies are changed with respect to synonyms, antonyms, abbreviated words and coined words for the predicate (first priority) and keywords (second priority) (operation S513) Like in the extraction process, the synonyms and antonyms may be checked on the basis of a dictionary DB, and the abbreviated words and coined words may be checked on the basis of an actually used and frequently used terminology DB.

The change of sentence pattern is performed to change the grammatical structure of the basic sentences (operation S514). For example, the change of sentence pattern may be performed with respect to a ‘do not’ negative sentence, a ‘cannot’ negative sentence, a short negative sentence, a long negative sentence, a dual negative sentence, and a ‘yi, hee, ri and gi’ passive sentence.

The word order is changed on the basis of main sentence components and keywords (operation S515). For example, the word order is changed with respect to ‘(subject)+(object)+predicate’, ‘(object)+(subject)+auxiliary/main predicates’, ‘predicate+object’ or ‘(object)+auxiliary predicate+(subject)+main predicate’, and ‘omission of basic component (subject)’.

The change of predicate is performed through the change of the stem of words (operation S516). More specifically, the change of predicate may further include conversational words (e.g. abridged words, euphonic replacement, exclamations, non-standard language, non-standard spelling of loan words) based on the change of stem and ending of verbs and adjectives, conversational style (e.g. imperative style).

The change of modifier is performed to add additional noun-repeating modifiers, adjective and adverb modifiers (operation S517).

The grammatical error is checked with respect to the corpora generated by the aforementioned changing and adding processes (operation S518). For example, spelling, orthography, word-spacing, and the tense may be checked with respect to the corpora.

Lastly, conservation of meaning is reviewed with respect to the completed corpora (operation S519).

Paraphrasing the basic sentences may be performed using the paraphrasing template.

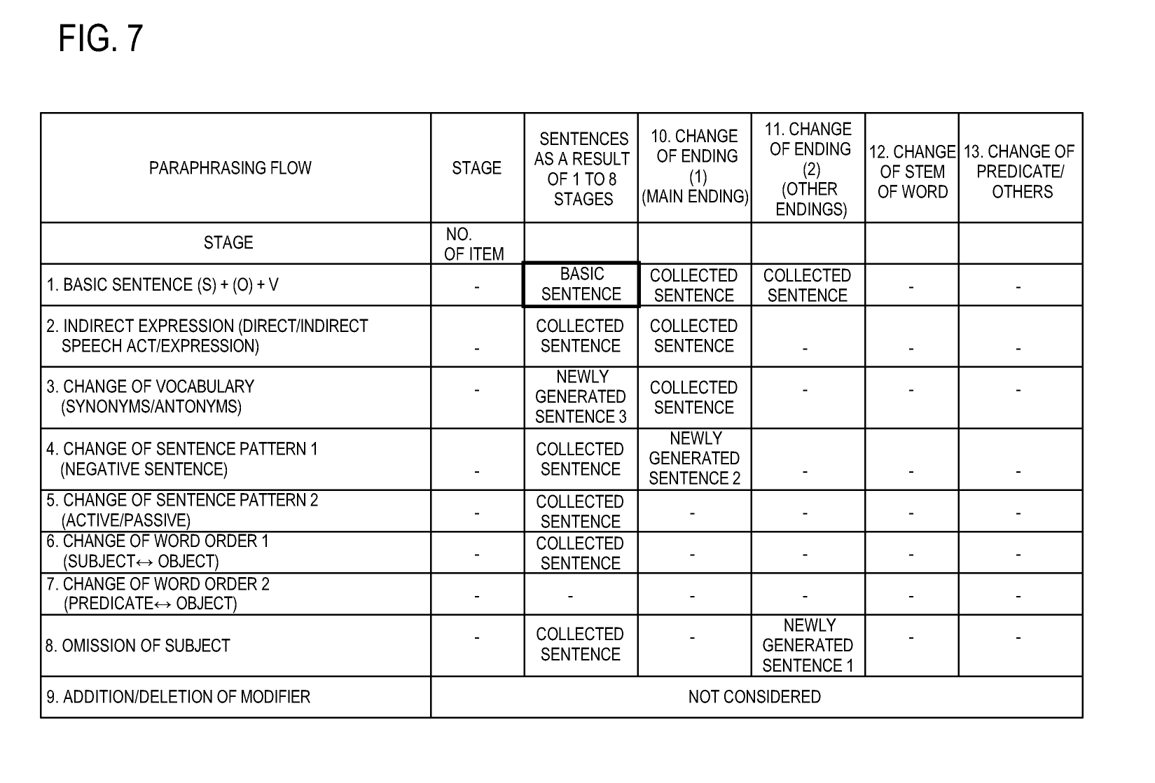

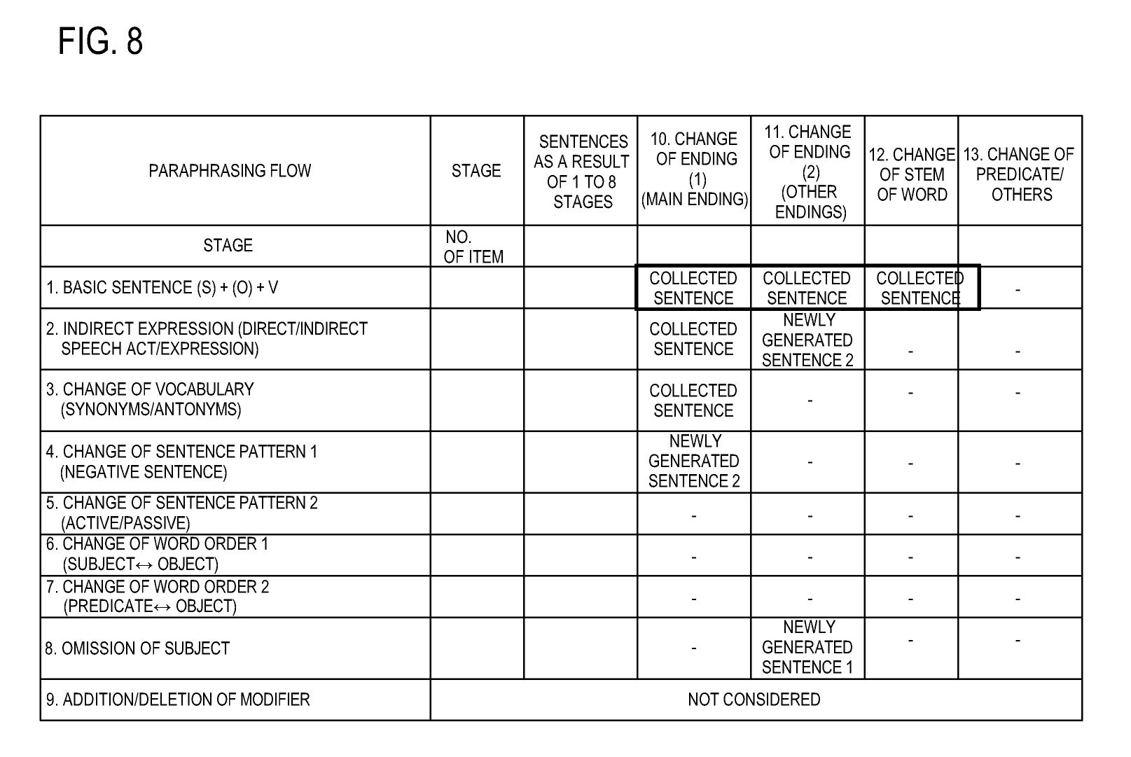

FIGS. 7 and 8 illustrate examples of paraphrasing templates, wherein a transverse axis may include a change of predicate including various changes of the endings of words and changes of the stem of words, and the vertical axis may include indirect expressions (direct/indirect speech act expression), change of vocabularies, change of sentence patterns, change of word order, and omission of subjects. The arrangement of the transverse axis and vertical axis may be otherwise changed.

FIG. 7 illustrates a paraphrasing template for a single basic sentence.

The basic sentence may be paraphrased in connection with the indirect expression (direct/indirect speech act expression), change of vocabularies, change of sentence pattern, change of word order and omission of subject in the vertical axis against the first row in the transverse axis.

The basic sentence and paraphrased basic sentence may be paraphrased by applying the change of ending of word 1 in the second row.

The basic sentence and paraphrased basic sentence may be further paraphrased by applying the change of ending of a word 2 in the third row, the change of stem of a word in the fourth row and the change of predicate and others in the fifth row.

FIG. 8 illustrates a paraphrasing template for a plurality of basic sentences.

The plurality of basic sentences with respect to the change of ending of word 1 (main ending), change of ending of word 2 (other endings), change of stem of words, and change of predicate and others as the main change of the ending of words in the third row in the basic sentence, i.e., subject+object+verb structure may be paraphrased by applying No. 2 indirect expression (direct/indirect speech act expression), No. 3 change of vocabulary, No. 4 change of sentence pattern 1, No. 5 change of sentence pattern 2, No. 6 change of word order 1, No. 7 change of word order 2 and No. 8 omission of subject.

The single or the plurality of basic sentences may be changed in various ways to paraphrase the corpora.

The speech recognition device according to the exemplary embodiment may accurately recognize a user's intention with respect to various corpora of various users.

Also, the speech recognition device according to the exemplary embodiment may store various and abundant data by function in connection with the functions of the speech recognition device.

The database according to the exemplary embodiment may be systemically paraphrased and stored as many corpora of various users based on the basic sentences obtained by refining and extracting the user's corpora.

The constructing method of the database according to the exemplary embodiment may conveniently paraphrase data.

Although a few exemplary embodiments have been shown and described, it will be appreciated by those skilled in the art that changes may be made in these exemplary embodiments without departing from the principles and spirit of the application, the range of which is defined in the appended claims and their equivalents.

What is claimed is:

1. A speech recognition device comprising:
a corpus processor which comprises a refiner which is configured to classify collected corpora into domains corresponding to functions of the speech recognition device, and an extractor which is configured to extract collected basic sentences with respect to the corpora in the domains, and extract basic sentences from a user's corpora;
a database (DB) which is configured to store therein the extracted basic sentences;
a corpus receiver which is configured to receive the user's corpora; and
a controller which is configured to compare a received basic sentence with collected basic sentences stored in the DB and determine a function intended by the user's corpora.

2. The speech recognition device according to claim 1, further comprising a function performer which is configured to perform the function determined by the controller.

3. The speech recognition device according to claim 1, wherein the corpus processor further comprises a paraphraser which paraphrases the extracted collected basic sentence and generates paraphrased collected corpora.

4. The speech recognition device according to claim 3, wherein the paraphraser paraphrases the extracted received basic sentences and generates paraphrased received corpora.

5. The speech recognition device according to claim 4, wherein the controller compares the paraphrased received corpora with the paraphrased collected corpora and determines the function intended by the user's corpora.

6. The speech recognition device according to claim 1, wherein the refiner analyzes a main act and key object of the collected corpora or the received corpora and classifies the collected corpora and the received corpora into domains corresponding to the user's intention.

7. The speech recognition device according to claim 1, wherein the extractor performs at least one of grammatical error filtering, predicate filtering, change of word order filtering, change of sentence pattern filtering, change of word order filtering, modifier filtering, and indirect expression filtering.

8. The speech recognition device according to claim 7, wherein the extractor sequentially performs the grammatical error filtering, the predicate filtering and the change of vocabulary filtering.

9. The speech recognition device according to claim 3, wherein the generation of the paraphrased collected corpora by the paraphraser is performed in a reverse order of the extraction of the collected basic sentences by the extractor.

10. The speech recognition device according to claim 4, wherein the generation of the paraphrased received corpora by the paraphraser is performed in a reverse order of the extracting of the received basic sentences by the extractor.

11. The speech recognition device according to claim 9, wherein the paraphraser comprises a paraphrasing template.

12. The speech recognition device according to claim 11, wherein a transverse axis of the paraphrasing template applies one of an indirect expression, a change of predicate, a change of vocabulary, a change of sentence pattern, a change of word order, and a change of modifier, and a vertical axis thereof applies another of the indirect expression, the change of predicate, the change of vocabulary, the change of sentence pattern, the change of word order, and the change of modifier.

13. A speech recognition method of a speech recognition device, the method comprising:
classifying collected corpora into domains consistent with functions of the speech recognition device;
extracting collected basic sentences based on functions of the speech recognition device from the corpora in the domains;
storing the extracted collected basic sentences based on the functions of the speech recognition device;
receiving a user's corpus; and
comparing a received basic sentence extracted from the received user's corpora with the stored collected basic sentences, and determining a function intended by the user's corpus based on a result of the comparing.

14. The speech recognition method according to claim 13, further comprising performing the determined function.

15. The speech recognition method according to claim 13, further comprising generating paraphrased collected corpora by paraphrasing the extracted collected basic sentences.

16. The speech recognition method according to claim 13, further comprising generating paraphrased received corpora by paraphrasing the extracted received basic sentence.

17. The speech recognition method according to claim 16, wherein the paraphrased received corpora are compared with the paraphrased collected corpora to determine the function intended by the user's corpus.

18. The speech recognition method according to claim 13, wherein the classifying into domains comprises analyzing a main act and key object of the collected corpora or the received corpora, and classifying the collected corpora and the received corpora into domains which correspond to the user's intention.

19. The speech recognition method according to claim 13, wherein the extracting comprises performing at least one of grammatical error filtering, predicate filtering, change of vocabulary filtering, change of sentence pattern filtering, change of word order filtering, modifier filtering, and indirect expression filtering.

20. The speech recognition method according to claim 19, wherein the extracting comprises sequentially performing the grammatical error filtering, the predicate filtering and the change of vocabulary filtering.

21. The speech recognition method according to claim 15, wherein the generating the paraphrased collected corpora is performed in a reverse order of the extracting of the collected basic sentence.

22. The speech recognition method according to claim 16, wherein the generating the paraphrased received corpora is performed in a reverse order of the extracting of the received basic sentence.

23. The speech recognition method according to claim 21, wherein the generating the paraphrased collected corpora or paraphrased received corpora comprises a paraphrasing template.

24. The speech recognition method according to claim 23, wherein a transverse axis of the paraphrasing template applies one of an indirect expression, a change of predicate, a change of vocabulary, a change of sentence pattern, a change of word order, and a change of modifier, and a vertical axis thereof applies another of the indirect expression, the change of predicate, the change of vocabulary, the change of sentence pattern, the change of word order, and the change of modifier.

25. A database for a speech recognition device, the database comprising:
collected basic sentence data which are extracted by classifying collected corpora into domains corresponding to functions of the speech recognition device, and by performing at least one of grammatical error filtering, predicate filtering, change of vocabulary filtering, change of sentence pattern filtering, change of word order filtering, modifier filtering, and indirect expression filtering with respect to the corpora in the domains.

26. The database according to claim 25, further comprising paraphrased collected corpora data which are generated by paraphrasing the extracted collected basic sentence.

27. The database according to claim 25, further comprising received basic sentence data which are extracted from received corpora received by the speech recognition device.

28. The database according to claim 27, further comprising paraphrased corpora data which is paraphrased from the received basic sentence.

29. The database according to claim 25, wherein the classification into domains is determined by analyzing a main act and key object of the collected corpora or received corpora.

30. The database according to claim 25, wherein the extraction comprises performance of grammatical error filtering, predicate filtering and change of vocabulary filtering.

31. The database according to claim 26, wherein the paraphrased collected corpora data are obtained by performing in a reverse order of the collected basic sentence.

32. The database according to claim 27, wherein the paraphrased received corpora data are obtained by performing in a reverse order of extracting the received basic sentence.

33. The database according to claim 31, wherein the paraphrased collected corpora data are obtained based on a paraphrasing template.

34. The database according to claim 32, wherein the paraphrased received corpora data are obtained by using a paraphrasing template.

35. The database according to claim 33, wherein a transverse axis of the paraphrasing template applies one of an indirect expression, a change of predicate, a change of vocabulary, a change of sentence pattern, a change of word order, and a change of modifier, and a vertical axis thereof applies another one of the indirect expression, the change of predicate, the change of vocabulary, the change of sentence pattern, the change of word order, and the change of modifier.

36. A constructing method of a database for a speech recognition device, the constructing method comprising:
classifying collected corpora into domains corresponding to functions of the speech recognition device and refining the corpora;
performing at least one of grammatical error filtering, predicate filtering, change of vocabulary filtering, change of sentence pattern filtering, change of word order filtering, modifier filtering, and indirect expression filtering and extracting collected basic sentence; and
storing the collected basic sentence based on the functions of the speech recognition device.

37. The constructing method according to claim 36, further comprising generating paraphrased collected corpora data by paraphrasing the extracted collected basic sentence.

38. The constructing method according to claim 36, further comprising extracting received basic sentence data from received corpora received by the speech recognition device.

39. The constructing method according to claim 38, further comprising generating paraphrased corpora data from the received basic sentence.

40. The constructing method according to claim 36, wherein the refining is performed by analyzing a main act and key object of the collected corpora or received corpora.

41. The constructing method according to claim 36, wherein the extracting comprises sequentially performing grammatical error filtering, predicate filtering and change of vocabulary filtering.

42. The constructing method according to claim 37, wherein the generating the paraphrased collected corpora comprises performing in a reverse order of extracting the collected basic sentence.

43. The constructing method according to claim 39, wherein the generating the paraphrased received corpora comprises performing in a reverse order of extracting the received basic sentence.

44. The constructing method according to claim 42, wherein the generating the paraphrased collected corpora is based on a paraphrasing template.

45. The constructing method according to claim 43, wherein the generating the paraphrased received corpora is based on a paraphrasing template.

46. The constructing method according to claim 44, wherein a transverse axis of the paraphrasing template applies one of an indirect expression, a change of predicate, a change of vocabulary, a change of sentence pattern, a change of word order, and a change of modifier, and a vertical axis thereof applies another of the indirect expression, the change of predicate, the change of vocabulary, the change of sentence pattern, the change of word order, and the change of modifier.
